(19) United States
(12) Patent Application Publication
(10) Pub. No.: US 2005/0074131 A1
(43) Pub. Date: Apr. 7, 2005

(54) Vehicular sound processing system

(76) Inventors: Clark E. Mc Call, Ann Arbor, MI (US); Raymond Kleinberg, Sterling Heights, MI (US)

Correspondence Address: CHRISTOPHER DEVRIES;General Motors Corporation, Mail Code 482-C23-B21, P.O. Box 300, Detroit, MI, 48265-3000, US

(21) Appl. No.: 10/679,598

(22) Filed: Oct. 6, 2003

(51) Int. Cl. H04B 1/00

(52) U.S. Cl. 381/86

(57) ABSTRACT

A sound processing system for use in an automotive vehicle of the type which includes at least one door and at least one door-lock comprises at least one sound sensor coupled to the vehicle for receiving a sound external to the vehicle, an alert generator for notifying an occupant of the vehicle when the external sound is an emergency signal, and a door control module coupled to at least one door-lock for unlocking at least one door. A sound processor is coupled to the sound sensor, the alert generator, and the door control module and receives and compares the external sound to first and second sets of characteristics. The sound processor activates the alert generator if the sound substantially matches the first set and the door control module if the sound substantially matches the second set.

### FIELD OF THE INVENTION

The present invention relates generally to a vehicular audible signal processing system, and more particularly to a vehicular sound responsive entry and emergency sound recognition system for facilitating keyless vehicle entry and for alerting an occupant of a vehicle to emergency sounds external to the vehicle (e.g. a siren).

### BACKGROUND OF THE INVENTION

Sound recognition technology has found many applications in modern automotive vehicles. In recent years, an increasing number of vocally controlled, in-cabin features have become readily available which simplify component use and decrease driver distraction. A driver may now, for example, be able to verbally activate a telephone dialing program, speak a word associated with a telephone number (e.g. “home”), converse, and deactivate the system without manual intervention. The interior of a vehicle is, in many ways, an ideal environment for sound recognition technologies; i.e. a driver has a high degree of control over ambient noise (e.g. the ability to adjust the volume on a stereo system), the cabins of vehicles are becoming quieter due to improved sound dampening technology, and single components (e.g. sound processors, microphones, programs, etc.) employed in sound processing systems (e.g. the OnStar system) may be shared in multiple applications.

As voice processing technology has progressed, user dependent applications wherein a particular user is identified by the pattern of his or her voice have been developed. Though such user dependent applications are feasible inside a vehicle for the reasons mentioned above, they are often impractical for use outside the vehicle where ambient noise is typically louder and beyond a user's control. For these reasons, vehicle entry systems capable of identifying a user based upon his or her particular voice pattern (i.e. user-dependent entry) that utilize microphones external to the vehicle, for example, are expensive to implement and relatively unreliable, notwithstanding that such a voice-based vehicle entry system would allow a user to enter a vehicle without a key or keyfob thus permitting a user who has lost their keys, locked their keys in the vehicle, or simply is not carrying a key to enter the vehicle. These advantages have, however, been largely realized by keypad systems well known in the art. Such systems may employ a numeric keypad located somewhere on the exterior of a vehicle (e.g. underneath a door handle), a memory for storing a code or a plurality of codes, and a processor/software to authenticate an entered sequence of numbers. Though such systems provide the abovementioned benefits, they are user independent (i.e. multiple users may use a single code) and thus allow a user to transfer the ability to access the vehicle by providing the entry code. Such systems also are relatively expensive, and the keypads associated with such systems may not be aesthetically pleasing.

As mentioned above, vehicle sound proofing has improved such that outside noise is increasingly more difficult to hear from within the cabin of a vehicle. Noise produced from other sources internal to the cabin such as a stereo system or cell phone makes it even more difficult to hear external sounds. As a result, a driver/occupant of a vehicle may not receive sufficient early notification of an approaching emergency vehicle. Emergency vehicles may be delayed by drivers who are slow to pull out of the way or who are completely unaware of the approaching emergency vehicle. It is known that such problems may be mitigated by equipping a vehicle with a receiver capable of receiving radio frequency signals emitted from approaching emergency vehicles equipped with corresponding transmitters. When the appropriate frequency is detected, the emergency vehicle warning systems notifies (e.g. by illuminating an indicator light) the automobile occupants. Though such systems work reasonably well, they are only effective when the emergency vehicle and the particular automobile are both provided with the appropriate equipment. Such systems are relatively costly and notify vehicle occupants of sirens associated with emergency vehicles only. That is, these systems do not provide detection of other (e.g. non-vehicle mounted) emergency sirens.

In another known siren detection system, an external microphone is coupled to a high pass filter and a level detector. If a sound is registered by the microphone that is higher in pitch than the frequency cut-off of the high pass filter and louder than the decibel cut-off of the level detector, the system provides a form of notification to the vehicle's occupants of an approaching emergency vehicle. Though systems of this type are relatively inexpensive to employ, such systems are subject to significant false alarms if filter and/or level detector thresholds are set too low. Conversely, if the respective thresholds are set too high, such systems are subject to non-detects.

It should thus be apparent that it would be desirable to provide a siren detection and keyless vehicle entry system that is reliable and inexpensive to implement.

### BRIEF SUMMARY OF THE INVENTION

According to a broad aspect of the invention there is provided a sound processing system for use on an automotive vehicle of the type which includes at least one door having a door-lock, comprising at least one sound sensor affixed to the vehicle for receiving an external sound. A sound processor is affixed to at least one external sound sensor and compares the characteristics of the external sound to a first predetermined set of characteristics when the vehicle is occupied and to a second set of characteristics when the vehicle is not occupied.

According to a further aspect of the invention there is provided a sound processing system for use on an automotive vehicle of the type which includes at least one door having a door-lock and door handle comprising at least one sound sensor affixed to the exterior of the vehicle for receiving sound and a vehicle occupancy sensor for indicating when the vehicle is occupied. The alert generator notifies the occupant when the external sound is an emergency signal and a door control module affixed to at least one door-lock will unlock the door. A sound processor affixed to the vehicle, occupancy sensor, alert generator and door control module will receive sound and compare it to a first set of characteristics if the vehicle is occupied and a second set of characteristics if the vehicle is unoccupied.

According to a further aspect of the invention there is provided a method for permitting keyless entry to an automotive vehicle and for alerting an occupant of the vehicle of an external emergency sound, the vehicle having at least one door equipped with a door lock and door access mechanism, comprising receiving an external sound and determining if the vehicle is occupied. The sound is compared with a first set corresponding to an emergency sound if the vehicle is occupied and with a second set corresponding to an audible access code if the vehicle is unoccupied. A user recognizable alert is generated if the sound substantially matches the first set, and the vehicle door is unlocked if the sound substantially matches the second set.

### BRIEF DESCRIPTION OF THE DRAWINGS

The present invention will hereinafter be described in conjunction with the following drawings, wherein like numerals denote like elements, and

FIG. 1 is a block diagram of a vehicular vocal signal processing system in accordance with the teachings of the prior art;

FIG. 2 is a block diagram of a vehicular audible signal processing system in accordance with a first embodiment of the present invention;

FIG. 3 is a block diagram of the vehicle entry portion of the vehicular audible signal processing system shown in FIG. 2; and

FIG. 4 is a block diagram of the vehicular emergency sound detection portion of the sound recognition system shown in FIG. 2.

### DETAILED DESCRIPTION OF THE INVENTION

The following detailed description of the invention is merely exemplary in nature and is not intended to limit the scope, applicability, or configuration of the invention in any way. Rather, the following description provides a convenient illustration for implementing exemplary embodiments of the invention. Various changes to the described embodiments may be made in the function and arrangement of the elements described herein without departing from the scope of the invention.

Vocal signal processing systems generally include a processor enabling analog-to digital-conversion of an incoming vocal signal and a memory containing a plurality of digital vocal templates or samples corresponding to different words or commands. Vocal signal processing systems are thus generally able to receive an analog vocal signal via an internal microphone (i.e. internal to the vehicle), convert the received analog signal to digital form, interpret the converted digital signal by comparison to a digital template, and execute a function corresponding to the interpretation. Such vocal signal processing systems are commonly known (e.g. the OnStar system) and have been increasing employed in motor vehicles.

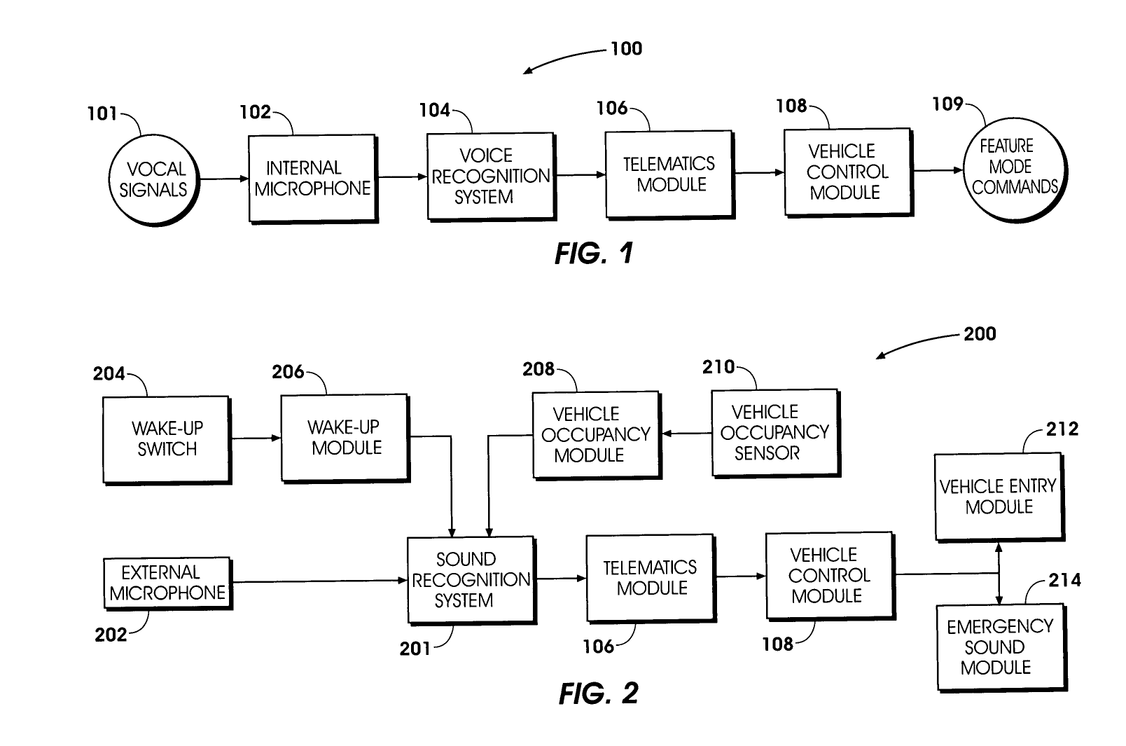

FIG. 1 is a block diagram of a vocal signal processing system 100 deployed in a motor vehicle in accordance with the teachings of prior art. Internal vocal signals 101 (i.e. internal to the vehicle) are produced by an occupant of a vehicle and received by an interior microphone 102. Internal microphone 102 is provided with an output coupled to an input of voice recognition system 104. Voice recognition system 104 is similarly provided with an output which is coupled to an input of telematics module 106 which, in turn, has an output coupled to an input of vehicle control module 108. Lastly, vehicle control module 108 is configured to issue control signals or feature mode commands 109 to at least one adjustable feature of the motor vehicle (e.g. steering wheel, headlamps, etc.) which instruct the feature to adjust in a particular way.

Voice recognition system 104 processes vocal signals 101 by conversion to digital form and by comparison to groups or sets of characteristics stored in a memory (not shown) associated with system 104. Specifically, voice recognition system 104 interprets vocal signals 101 by comparing the characteristics thereof to sets of predefined characteristics of templates or samples of digital waveforms corresponding to particular words or commands (e.g. a feature mode command such as “activate headlamps”). If the characteristics of vocal signals 101 are sufficiently similar to those of one or more stored templates, voice recognition system 104 signals a match to vehicle control module 108 via telematics module 106. Vehicle control module 108 then instructs a vehicle feature to adjust in accordance with the mode command. For example, if voice recognition system 104 interprets vocal signals 101 to be sufficiently similar to a template associated with the activation of the vehicle's headlamps, voice recognition system 104 would send an ACTIVATE HEADLAMPS message to vehicle control module 108 which, in turn, would cause the vehicle headlamps to turn on.

Telematics module 106 enables wireless communication (i.e. via a cellular phone connection) with an off-board system. In this way, telematics module 106 may permit a vehicle occupant to access live operators (e.g. having access to a database of geographical maps, user data, etc) and an automated voice recognition system (e.g. having a server responsive to vocal commands and capable of providing information regarding sports statistics, stocks, weather, etc.). Telematics module 106 may also permit additional, off-site processing of vocal signals 101 and may receive signals issued from an off-site source thus enabling remote adjustment of vehicle features (e.g. a driver locked out of a car may have the car doors remotely unlocked).

FIG. 2 is a block diagram of a vehicular audible signal processing system 200 in accordance with a first embodiment of the present invention. Audible signal processing system 200 comprises a telematics module 106 and vehicle control module 108 of the type shown and described above in conjunction with FIG. 1. As can be seen, voice recognition system 104 (FIG. 1) has been replaced with a sound recognition system 201. Sound recognition system 201 is capable of performing the same voice processing tasks described above in conjunction with voice recognition system 104 but may also interpret non-voice based sounds (e.g. sirens).

Sound recognition system 201 includes at least three inputs coupled to the outputs of wake-up module 206, external sound sensor (i.e. microphone) 202, and vehicle occupancy module 208. Sound recognition system 201 may also be coupled to an internal microphone (not shown) of the type shown and described above in conjunction with FIG. 1. Wake-up module 206 and vehicle occupancy module 208 are further provided with inputs coupled to the respective outputs of wake-up switch 204 and vehicle occupancy sensor 210. As is described more fully hereinbelow, wake-up switch 204 and wake-up module 206 activate the system prior to entry into the vehicle, and vehicle occupancy sensor 210 and vehicle occupancy module 208 inform sound recognition system 201 when the vehicle is occupied.

Sound recognition system 201 further comprises a single output which is coupled to telematics module 106. Telematics module 106 is similarly provided with an output coupled to an input of vehicle control module 108. Lastly, as is shown in FIG. 2, vehicle control module 108 has an output coupled to the inputs of two vehicle feature modules (i.e. vehicle entry module 212 and emergency sound module 214). Vehicle entry module 212 controls adjustable vehicle features associated with vehicle entry (e.g. door locks), and emergency sound module 214 controls adjustable vehicle features capable of generating user recognizable emergency sound notifications (e.g. a visual indication such as a warning light).

It should be appreciated that external microphone 202 and external wake-up switch 204 are each located substantially on the exterior of the vehicle. For example, external wake-up switch 204 may take the form of a door handle (e.g. the driver side door handle) and external microphone may be positioned, for example, underneath the door handle. External microphone 202 is positioned on the outside of the vehicle to detect primarily sounds produced by two different external sources: close-proximity sources such as nearby human speakers, and more distant sources such as emergency traffic alerts (e.g. sirens). The external sounds received by external microphone 202 may be processed by audible sound recognition system 201 in one of two ways: by comparison to at least one set of predefined digital waveform characteristics associated with alphanumeric sounds or by comparison to at least one set of predefined digital waveform characteristics associated with emergency traffic notification alerts. Depending upon the results of the comparison, sound recognition system 201 may then send instructional signals to either vehicle entry module 212 or emergency sound module 214, such as an UNLOCK VEHICLE DOORS signal or an ILLUMINATE WARNING LIGHT signal respectively.

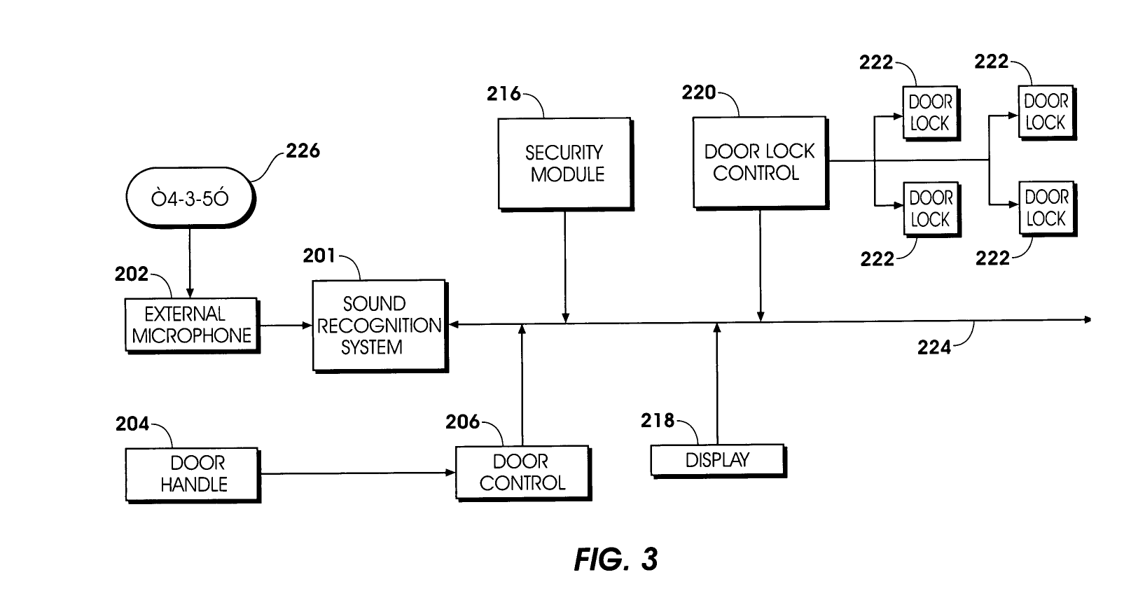

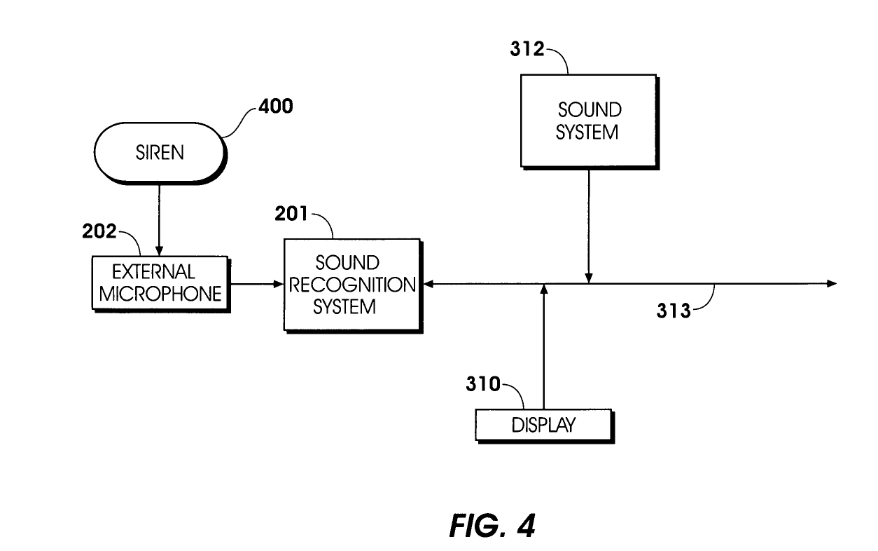

As stated above, vehicle occupancy module 208 receives signals from vehicle occupancy sensor 210 which senses a condition indicative of an operator's presence within the vehicle. For example, vehicle occupancy sensor 210 may monitor such conditions as the opening of vehicle doors, vehicle movement, or vehicle ignition. Upon detection of a condition indicative of vehicle occupancy, vehicle occupancy sensor 210 signals vehicle occupancy module 208 which, in turn, sends a signal indicative of vehicle occupancy to sound recognition system 201. That is, if the vehicle is occupied, sound recognition system 201 will cease comparing external sound signals received by external microphone 202 to characteristic sets associated with alphanumeric code entry sounds and instead compare the incoming sound signals to characteristic sets associated with emergency related sounds. In a similar manner, the vehicle occupancy signal or lack thereof will determine whether sound recognition system 201 sends instructional signals to vehicle entry module 212 or emergency sound module 214 as is more fully discussed below in conjunction with FIGS. 3 and 4 respectively.

Due to vehicle battery limitations, it would be impractical for sound recognition system 201 to operate for extended periods of time when a vehicle's engine is not running. The present invention thus seeks to reduce power requirements by means of wake-up switch 204 which may be, as stated above, incorporated into the driver side door handle. Upon activation (e.g. lifting of the door handle), external wake-up switch 204 signals wake-up module 208 which, in turn, sends a WAKE-UP signal to sound recognition system 201. When receiving such a WAKE-UP signal, sound recognition system 201 changes from a dormant or non-processing mode to an active or processing mode wherein external sound signals received by external microphone 202 are processed. Sound recognition system 201 will continue in this active mode until occupancy module 208 no longer receives an occupancy signal, after which sound recognition system 201 again enters its dormant state until a wake-up signal from module 206 is received. Furthermore, the active mode may last for a predetermined period of time (e.g. ten minutes), after which sound recognition system 201 returns to its dormant mode if the vehicle remains unoccupied. It should be appreciated that energy concerns noted above are significantly less important when a vehicle's engine is running as is typically the case when the vehicle is occupied. Thus, sound recognition system 201 may remain in an active mode indefinitely while a vehicle's engine is running.

FIG. 3 is a block diagram of the vehicle entry portion of the vehicular audible signal processing system 200 shown in FIG. 2. Vehicle occupancy module 210, telematics module 106, vehicle control module 108, and emergency sound modules 214 are not shown for clarity. FIG. 3 comprises a sound recognition system 201 and external microphone 202 of the type shown and described above in conjunction with FIG. 2. Vehicle entry module 212 (FIG. 2) is represented as comprising a security module 216, a display 218 (e.g. an LCD), and a door lock control 220 having an output coupled to a plurality of door lock mechanisms 222 so as to control the locking and unlocking of at least one (e.g. four) vehicle doors. As can be seen in FIG. 3, wake-up module 206 and wake-up switch 204 (FIG. 2) are now represented as door control 206 and door handle 204 respectively. Sound recognition system 201, door control 206, security module 216, door lock control 220, and LCD display 218 are coupled together via serial data bus 224.

It should be appreciated that display 218 may take any suitable form. For example, display 218 may comprise a LED light mounted on the exterior of a vehicle. Alternatively, display 218 may be replaced by a different feedback means such as a sound generator (e.g. a tone generator). Display 218 may display a user recognizable response after the reception of a correct numerical sequence, or if desired may provide positive feedback after identification of each digit of a multi-digit code.

Door handle 204 is first lifted sending a WAKE-UP signal to door control 206 which, in turn, places a WAKE-UP signal on serial data bus 224. Sound recognition system 201 receives the WAKE-UP signal and begins to monitor external microphone 202 for external sounds. A spoken numerical code 226 (e.g. “4-3-5”) is received by external microphone 202 and delivered to sound recognition system 201 where it is converted to digital form and compared to sets of characteristics associated with various numeric or alphanumeric sounds. After converting and identifying spoken code 226, sound recognition system 201 places the code on serial data bus 224. Next, security module 216 compares code 226, now in digital form, to a predetermined access code stored in a memory. If spoken code 226 and the access code match, security module 216 places a CODE OKAY signal on data bus 224. Display 218 then receives the CODE OKAY signal and produces a user recognizable response. For example, display 218 may display a textual message such as “Code Accepted.” The CODE OKAY signal is also received by door lock control 220 which instructs door locks 222 to unlock.

It should be appreciated that though the entry code has been described as consisting of three numbers, any combinations of words, numbers, or characters may be used. However, it is preferable that the entry code consist of a few (e.g. four or five) alphanumeric characters because (1) such multi-digit codes are relatively easy to identify using modern sound recognition systems and thus provide a relatively reliable entry means, and, (2) such codes may be user-independent (i.e. not specific to a particular person's voice) and thus require no enrollment or training phase. This also allows a user to permit anyone to enter the vehicle by simply giving them the entry code. It should further be appreciated that, although the invention has been described in connection with unlocking all vehicle doors upon receipt of the correct entry code, any desired task could be executed upon detection of match; additional vocal commands may also be accepted at this time and executed using the above described techniques. For example, after detection of a vehicle entry code, a user may then unlock the vehicle doors by saying, “Unlock all doors,” or activate a security alarm with a vocal command, “Alarm On,” etc.

In the interest of security, it may be desirable to provide audible signal processing system 200 with a timed exclusion or lock-out feature wherein sound recognition system 201 enters an uninterruptible dormant mode after a predefined number of mismatches have been consecutively detected. For example, security module 216 may place an INCORRECT CODE signal on data bus 224 after determining that a spoken code does not match the stored access code. After receiving a predefined number of such signals (e.g. three), sound recognition system 201 could then enter a dormant mode for a predetermined period of time (e.g. five minutes) after which wake-up switch/door handle 204 must again be lifted to place sound recognition system 201 in an active mode.

For convenience, multiple codes may be associated with multiple drivers. For example, a first driver may be associated with a first code (e.g. 1-2-3), and a second driver may be associated with a second code (e.g. 1-2-4). The audible signal processing system may thus identify drivers by way of their respective vehicle entry codes. In this way, a vehicle permitting driver profiles (e.g. user preferential settings of adjustable features in a memory) may manipulate personalizable vehicular features in accordance with the driver's preferred settings upon driver identification (i.e. after reception of a particular vehicle access code associated with a particular driver). Thus, after determining the identity of a particular driver by way of a driver-specific entry code, the driver's feature settings may be recalled, and the vehicle features may be adjusted accordingly.

FIG. 4 is a block diagram of the vehicular emergency sound detection portion of audible signal processing system 200 (FIG. 2). Wake-up switch 204, wake-up module 206, vehicle occupancy module 208, vehicle occupancy sensor 210, telematics module 106, vehicle control module 108, and vehicle entry modules 212 are not shown in FIG. 4 for clarity. Referring to FIG. 4, there is shown a sound recognition system 201 and an external microphone 202 of the type shown and described above in conjunction with FIG. 2. As can be seen, emergency sound module 214 (FIG. 2) is represented in FIG. 4 as sound system 312 and display 310. Sound recognition system 201, display 310, and sound system 312 are coupled by way of serial data bus 313.

External emergency sounds 400 are first detected by external microphone 202 and transmitted to sound recognition system 201 for conversion and processing. As has been described above, sound recognition system 201 processes incoming external sound signals by comparing them to a group of characteristics associated with emergency traffic notification alerts (e.g. sirens). If the characteristics of the received signals and the emergency sound template are sufficiently similar (e.g. the received signal meets predetermined frequency, amplitude, and/or other characteristics that are indicative of, for example, a siren), an EMERGENCY SOUND DETECTED message is then placed on serial bus 313. Display 310 and sound system 312 receive the EMERGENCY SOUND DETECTED signal and each produce a user recognizable indication that an emergency sound has been detected; display 310 provides a visual indication (e.g. illumination of a dashboard mounted light) in response to the signal, and sound system 312 provides an audible alert (e.g. a prerecorded vocal announcement produced via the vehicle's speaker system). It should be appreciated that although a combination of visual and audible indications are provided in FIG. 4, any suitable indication means or combination thereof (e.g. instrument panel lights, interior buzzers, radio interruption circuits, etc.) may be employed.

It should be appreciated that, although FIGS. 2-4 show all sound recognition processing occurring on-board the vehicle via sound recognition system 201, additional processing may take place off-board via telematics module 106 described above in above conjunction with FIG. 1. Additionally, telematics module 106 enables off-board processing completely independent of on-board processing so that, if desired, audible signals received by external microphone 202 could be processed entirely off-board and resulting instructions for adjusting vehicular features may be transmitted back to a vehicle in the same manner. It should further be appreciated that, although only one external sound sensing device is shown in FIGS. 2-4, it may be desirable to deploy a plurality of external microphones so as to (1) facilitate vehicle entry from the passenger side of a vehicle, and/or, (2) permit geographical/directional determination of an emergency sound source. Lastly, it should also be appreciated that the inventive audible signal processing system may be deployed in conjunction with other vehicle entry systems (e.g. conventional keypad entry systems).

It should thus be appreciated that a relatively reliable and accurate audible signal processing system capable of providing keyless vehicle entry and emergency sound detection has been provided. Many of the components utilized within the inventive system may be shared with a preexisting voice recognition system such as the OnStar system.

1. A sound processing system for use in an automotive vehicle of the type which includes at least one door and at least one door-lock, said sound processing system comprising:
at least one sound sensor coupled to said vehicle for receiving sound external to said vehicle; and
a sound processor coupled to said at least one sound sensor for comparing said sound signals to first and second predetermined sets of characteristics corresponding respectively to first and second categories of sound.

2. A sound processing system according to claim 1 wherein said at least one sound sensor is a microphone.

3. A sound processing system according to claim 2 further comprising a user input coupled to said sound processor and located substantially on said vehicle's exterior for activating said sound processor when said vehicle is not occupied.

4. A sound processing system according to claim 3 wherein said sound processor is activated for a predefined time period.

5. A sound processing system according to claim 4 wherein said external sound comprises a vehicle access code.

6. A sound processing system according to claim 5 wherein said second set of predetermined characteristics correspond to a correct vehicle access code.

7. A sound processing system according to claim 4 wherein said external sound comprises an emergency traffic alert.

8. A sound processing system according to claim 7 wherein said first set of predetermined characteristics correspond to an emergency traffic alert.

9. A sound processing system according to claim 8 wherein said emergency traffic alert is a siren.

10. A sound processing system according to claim 6 wherein said user input comprises at least one door handle.

11. A sound processing system according to claim 10 further comprising a feedback generator for providing a user recognizable response when at least a part of said access code is recognized by said processor.

12. A sound processing system according to claim 11 wherein said feedback generator comprises a display.

13. A sound processing system according to claim 11 wherein said feedback generator comprises a light-emitting diode.

14. A sound processing system according to claim 11 wherein said feedback generator comprises a sound generator.

15. A sound processing system according to claim 8 wherein said at least one microphone comprises at least a first microphone located proximate a front end of said vehicle and at least a second microphone located proximate a back end of said vehicle.

16. A sound processing system for use on an automotive vehicle of the type which includes at least one door having a door-lock and a door handle, said system comprising:
at least one sound sensor coupled to the exterior of said vehicle for receiving an external sound;
a vehicle occupancy sensor for indicating when said vehicle is occupied;
an alert generator for notifying an occupant of said vehicle when said external sound is an emergency signal;
a door control module coupled to said door-lock for unlocking said door; and
a sound processor coupled to receive said external sound and coupled to said vehicle occupancy sensor, said alert generator, and said door control module for comparing said sound to a first set of characteristics if said vehicle is occupied and to a second set of characteristics if said vehicle is unoccupied, said sound processor for activating said alert generator if said vehicle is occupied and said sound substantially matches said first set and for activating said door control module if said sound substantially matches said second set and the vehicle is unoccupied.

17. A sound processing system according to claim 16 wherein said at least one sound sensor is a microphone.

18. A sound processing system according to claim 17 wherein said sound processing system is activated upon actuation of said door handle.

19. A sound processing system according to claim 18 wherein said sound processor is activated for a predefined time period.

20. A sound processing system according to claim 19 wherein said second set corresponds to a vehicle access code.

21. A sound processing system according to claim 19 wherein said first set corresponds to an emergency traffic alert.

22. A sound processing system according to claim 20 further comprising a feedback generator for providing a user recognizable response when at least a part of said access code is recognized by said processor.

23. A sound processing system according to claim 22 wherein said feedback generator comprises a display.

24. A sound processing system according to claim 15 wherein said at least one microphone comprises at least a first microphone located proximate a front end of said vehicle and at least a second microphone located proximate a back end of said vehicle.

25. A method for providing keyless entry to an automotive vehicle and for alerting an occupant of said vehicle of an external emergency sound, said vehicle having at least one door equipped with a door lock and door access mechanism, said method comprising:
receiving an external sound;
determining if said vehicle is occupied;
comparing said sound with a first and second sets of characteristics, said first set corresponding to an emergency sound and said second set corresponding to an audible access code;
generating a user recognizable alert if said sound substantially matches said first set; and
unlocking said door if said sound substantially matches said second set.

26. A method according to claim 25 wherein said user recognizable alert is a visual alert.

27. A method according to claim 25 further comprising generating a system activation signal before said comparing.
